(19) United States
(12) Patent Application Publication
(10) Pub. No.: US 2003/0142590 A1
(43) Pub. Date: Jul. 31, 2003

(54) Smoking reduction method and device

(76) Inventor: Michael P. Eschenbrenner, Gibsonburg, OH (US)

Correspondence Address: MICHAEL P. ESCHENBRENNER, 1400 Kimball Road, Gibsonburg, OH, 43431, US

(21) Appl. No.: 10/059,979

(22) Filed: Jan. 30, 2002

(51) Int. Cl. G04F 8/00; G04F 10/00

(52) U.S. Cl. 368/107

(57) ABSTRACT

The present invention provides for a programmable, period-based, time-interval monitoring system, and method, for the managed reduction of cigarette smoking over time. The purpose of the method and device is to assist and provide information for a user to manage cigarette consumption over time, at a rate set by the user, to a goal value set by a user.

### BACKGROUND

The present invention relates generally to the field of health maintenance, and more specifically to the elimination of cigarette addiction through the gradual reduction in the number of cigarettes smoked each day.

The U.S. Surgeon General, the National Institute of Health, and various medical research societies, have all reached the conclusion that smoking is the leading cause of numerous diseases including; cardiovascular disease and cancers of the lungs and respiratory system.

Cigarette smoking is an addiction, with nicotine the primary chemical addictive substance. As with all addictions, it is very difficult to cease consumption all at once. Such a cold turkey approach, produces powerful cravings that are likely to result in the resumption of the addictive behavior. Instead, a gradual withdrawal produces tolerable side affects and is self-reinforcing.

Decreasing cigarette consumption over a period of time requires an inordinate amount of attention on behalf of the smoker: they must plan out in advance a reduction program, then monitor the time at which they smoke, they also must then remain cognizant throughout the day that they are attempting a reduction.

It is also well documented that the smoking habits of an individual smoker vary significantly throughout the day. Heavy smoking will occur upon awaking as the smoker replenishes the nicotine lost in the body from the night's sleep. Since most work places discourage smoking during work hours, smoking will decrease in an individual during the actual working hours of the day. At work time break periods and during the lunch hour, again smoking will be heavier, as the smoker replenishes lost nicotine levels, and in anticipation of the afternoon work hours where smoking again will be restricted. After-work, a smoker can smoke more uniformly as the no-smoking requirements of the work place are gone.

Various inventors have devised a number of timer controlled cigarette dispensers, devices and methods, for the purpose of assisting users in smoking cessation.

Disclosed in U.S. Pat. No. 6,125,082 is a cigarette dispenser to limit the number of cigarettes available to a smoker. This patent claims a locked case dispenser that provides cigarettes to a user for consumption, only after a preset time interval is reached. It is claimed by this invention, that once the time interval is entered it can not be changed until the contents of the dispenser have been consumed. It is further claimed that the interval can be programmed to be constant throughout the dispensing cycle, or it can be programmed to be incrementally increasing in duration throughout the dispensing cycle, however, it specifically indicates that the interval once programmed, can not be changed.

To illustrate the shortcomings of U.S. Pat. No. 6,125,082, consider a typical 30 cigarette (1½ packs) per day smoker, who rises at 6 am, goes to work at 8 am, (were smoking is not allowed except at break-times and lunch time) has two 15 minute breaks and a one hour lunch period. The smoker leaves work at 5:00 pm and goes to bed at 10 pm, for a 16 hr day. For a one-cigarette reduction from the initial 30, this user would program the device to indicate 31 minutes more or less between cigarettes. If this user smoked a cigarette initially upon awakening, they would be allotted another at 6:31 am, 7:02 am and then again at 7:33 am. This user would then miss their next allotted cigarettes, at 8:04 am, 9:04 am and 9:35 am because of work rules. If the users first work break were at 10:00, they would be allowed their scheduled 10:06 am cigarette, but would then miss their 10:37, 11:08 and 11:39 am cigarettes, again because of work rules. Following this through, they would be allowed the 12:10 and 12:41 pm cigarettes, but after lunch they would miss their 1:12, 1:33, 2:04, 2:35 pm scheduled cigarettes during work hours. They would be allowed their 3:06 pm cigarette, assuming their afternoon break was 3:00 till 3:15 pm, but then miss again their 3:37, 4:08 and 4:39 pm cigarettes. Once out of work, they could finish out their scheduled cigarettes at 5:10, 5:41, 6:02, 6:33, 7:04, 7:35, 8:06, 8:37, 9:08, 9:39 and 10:10 pm respectively. As illustrated by this scenario, instead of providing 29 scheduled cigarettes to this user, the device in U.S. Pat. No. 6,125,082 only provided 18 cigarettes, at irregular intervals throughout the day. The user of this device most certainly would be discouraged.

The main shortcoming of the “rigid time interval” method employed by the device in U.S. Pat. No. 6,125,082, is that this method does not take into account that a smoker needs increased nicotine levels at various periods throughout the day, in order to maintain what they perceive as a desirable nicotine level. It is an assertion of the present invention, that the 30 cigarette per day smoker mentioned in the example, will need 9 cigarettes in the first two hours of the day, to get their body up to what it perceives as its normal nicotine level. Only after this ramp up period, can the time increment be lengthened. The “rigid time increment method” employed by U.S. Pat. No. 6,125,082 provides only 4 cigarettes to this individual in the critical ramp up period described.

Disclosed in U.S. Pat. No. 5,778,897, another timed-release cigarette case is claimed. This device again employs the “rigid time increment” reduction method similar to U.S. Pat. No. 6,125,082, with the caveat that only trained professionals can vary, the again, “rigid time period”. And as discussed, this device too fails to recognize that “time period”, not “incremental time”, cigarette consumption management, is required if the user is to be assisted through the withdraw ordeal with minimal and tolerable side effects.

Disclosed in U.S. Pat. Nos. 5,566,855; 5,405,045; 5,203,472; 4,862,4311; 4,853,854; 4,620,555; 4,615,681; 4,076,118 and 3,999,412, again are different embodiments of the same “rigid time interval” method. And again, the failure to address the specific time period nicotine needs of a user trying to reduce consumption, can be summarized as previously discussed.

Disclosed in U.S. Pat. No. 6,305,839 is a wristwatch to aid in smoking cessation. Although similar in embodiment to the present invention, it too utilizes a “rigid time increment” method as its cessation program. And again, its failure to address the specific time period nicotine needs of a user trying to reduce consumption, can be summarized as previously discussed.

### SUMMARY OF THE INVENTION

The present invention provides for a user programmable, period-based, time-interval monitoring system and smoking reduction method, embodied in a watch like device, to provide a user with information for the managed reduction of cigarette smoking. The method and device assist with smoking reduction by utilizing incremental time management within daily time periods, and providing this management information to a user on a display.

The watch-like device contains a micro-processor, with programming prompts which allow the user to input information as to their smoking habit. This initial “smoking habit” information includes; starting number of cigarettes consumed daily (SCC), goal number of cigarettes to be smoked daily (GDG), hold days at intermediate reduction levels (HD), and program reset hour (URH). Once programmed, the smoking reduction method operates automatically within the device, until the goal value is attained, at which point the reduction method operates to hold a user at this goal value. The only user interface required after initial programming, is to acknowledge a smoking event by operation of the enter pushbutton.

One of the unique features of the method's reduction programming, consists of managing cigarette smoking within at a minimum, two distinctly different time periods. The first time period commencing when the user first awakens and indicates to the device that a cigarette will be consumed, and continuing for two hours thereafter. This first time period is allocated 30 percent of the planned daily cigarette consumption. This consumption is scheduled automatically, in even time increments within the first time period, and indicated as such to the user by the device. The second time period, which consists of the time from the end of the first time period until the user retires for the day, is allocated the remaining 70 percent of the planned daily cigarette consumption. Again, this consumption is scheduled automatically, in even time increments, and indicated as such to the user by the device.

In both the first and second time periods, the device displays when cigarettes should be consumed. The device also displays if a user is consuming cigarettes at a rate faster than the method programming, or at a rate equal to the method programming, or at a rate slower than the method programming.

The method and device are not “limiting” with respect to authorized smoking opportunities. If a user wishes to skip a planned cigarette smoking opportunity, or wishes to not smoke the planned cigarette at the exact time it is authorized, or experiences conditions where smoking the particular cigarette is not possible, this is noted on the device's display by incrementing the authorized smoking event indicator (C'STAT)+1. This smoking opportunity can then be undertaken by the user, whenever they so desire.

The method and device are also not limiting with respect to the overall day as a whole. As will be seen within this document, the method analyzes a users daily “pass or fail” status, 16 hours after starting the day's routine. Should a user experience a day longer than this for example, the method would still analyze their “pass or fail” status 16 hours after the start of their day, however, the method would still authorize smoking events past the end of this 16 hour period.

The purpose of the method and device is to decrease cigarette consumption over time, to a goal value set by the user.

The device is provided with pushbuttons for entering user data, and display screens for a user to view information and their current status.

Once the user has entered the appropriate information regarding their smoking habit, the devices programming automatically reduces planned daily cigarette consumption over time, until the users preset goal value has been attained.

In addition to time period management, the reduction method programming allows for “hold days” at intermediate reduction values. To illustrate the purpose of “hold days”, consider a 30 cigarette per day smoker, who has entered a goal value (GDG) of 20 cigarettes per day. Upon entering a starting value (SCC) of 30 and a goal value (GDG) of 20, the device's CPU will calculate the difference between the two values as 10. The reduction method programming, requires “hold days” at 30% of the reduction goal. “Hold days” are days where the user does not decrease cigarette consumption, but “holds” at the previous day's values to allow their body to become acclimated to the lower, more regulated nicotine level. The user can program “hold days” to be any amount from 1 day at a minimum, up to and including 99 days. For the 30 cigarette per day smoker discussed, who's goal value is 20, they would first hold at an intermediate reduction value of 27 cigarettes per day, for the number of “hold days” initially programmed into the device. If it is assumed that this user initially programmed a “hold days” value of five days, then five days must pass at 27 cigarettes consumed per day, before a reduction to 26 cigarettes consumed per day is undertaken. After completion of the “hold days” at 27 cigarettes per day, the devices CPU, in accordance with the method programming, will calculate a new “hold days” intermediate reduction value, based on the new starting point of 27, the original goal of 20, and the method programming of a 30% reduction to intermediate hold. This program subroutine continues over and over until the goal value is attained.

In addition to managing smoking opportunities in the minimum two time periods, the device is also capable of managing smoking opportunities in any number of additional periods contained within the two minimum time periods. This is very helpful in managing a smokers withdrawal, as a normal smoker's day usually consists of time periods where a user can smoke, followed by time periods where smoking is not allowed.

### BRIEF DESCRIPTION OF DRAWINGS

FIG. 1 is an isometric view of the preferred embodiment for the smoking reduction method.

FIG. 2 is a frontal, left, and right side view of the preferred embodiment for the smoking reduction method.

FIG. 3 shows LCD screen 1 of the preferred embodiment for the smoking reduction method.

FIG. 4 shows LCD screen 2 of the preferred embodiment for the smoking reduction method.

FIG. 5 shows LCD screen 3 of the preferred embodiment for the smoking reduction method.

FIGS. 6a, 6b, 6c, 6d show the functional block diagrams of the smoking reduction method's period based programming, contained within the preferred embodiment.

FIGS. 7a, 7b show graphically the difference between the present inventions reduction method utilizing “time period” management and the “rigid time interval” reduction methods of prior art.

FIGS. 8a, 8b show graphically how the present invention's method handles additional smoking periods contained within the minimum two time periods. And again illustrates the differences between the present invention's “period based” reduction method, and the “rigid time interval” reduction method of the prior art.

FIGS. 9a, 9b, 9c, 9d, 9e, 9f, show graphically the period based reduction method's reduction curve over time. These graphs assume a starting cigarette count (SCC) value of 20, a goal cigarette count (GDG) value of 10, a unit reset hour (URH) of 3:00 am, and programmed hold days (HD) of 5. These graphs present the reduction curve in its simplest form.

FIGS. 10a, 10b, 10c, 10d, 10e, 10f, show graphically the period based reduction method's reduction curve over time. These graphs again assume a starting cigarette count (SCC) value of 20, a goal cigarette count (GDG) value of 10, a unit reset hour (URH) of 3:00 am, and programmed hold days (HD) of 5. These graphs present the reduction curve for a more complex example, and show how the reduction method manages additional periods of smoking versus non-smoking contained within the minimum two time periods as a whole.

### DETAILED DESCRIPTION OF THE DRAWINGS

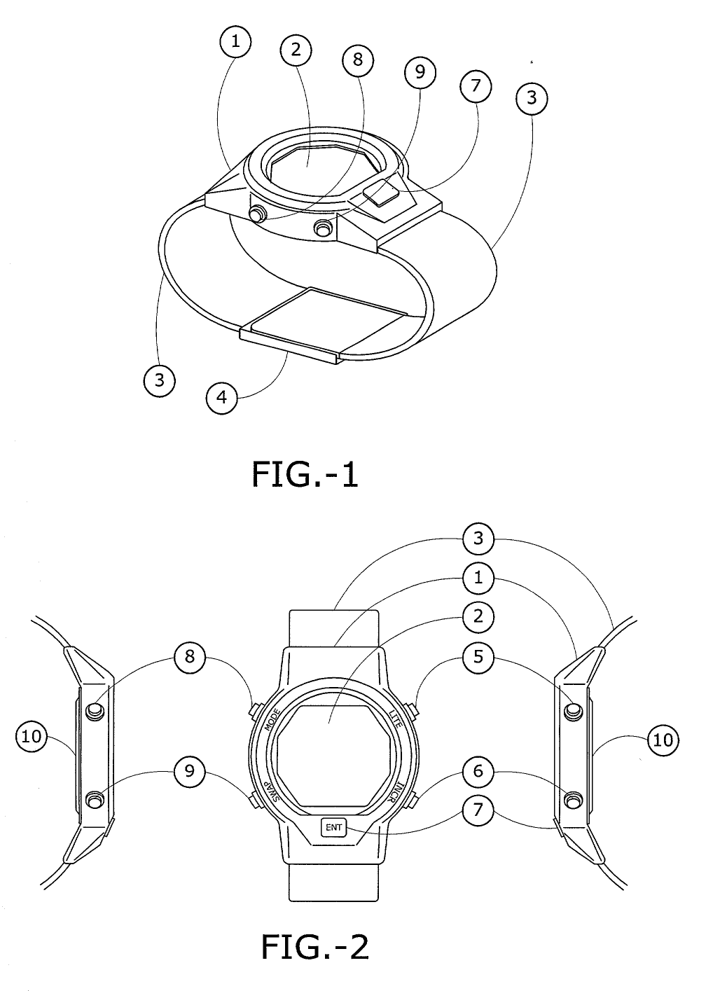

FIG. 1 shows the unit body (1) of the preferred embodiment. The device is similar to a watch with a clear plastic cover (2). Under the cover (2) is an LCD screen. A normal watch band (3) and clasp (4), hold the device on a users wrist.

FIG. 2 shows front, left and right side views of the preferred embodiment. As shown, the unit has five pushbuttons (5,6,7,8,9) and a back-plate (10)

Push button (7), located on the front of the device, is similar to the enter key of a computer. A user would operate this pushbutton to indicate the consumption of a cigarette. When programming the device, the enter pushbutton (7) is used to accept data values.

Pushbutton (5), located on the side of the unit body, will turn on a light when pushed, which illuminates the LCD screen.

Push button (6), also located on the side of the unit body, is an increment push button, utilized in the programming mode to increment data values.

Push button (8), is a mode pushbutton, which allows the user to switch between the operating mode, and program mode when pushed.

Push button (9) allows for the user to switch between the 3 different LCD information screens of the device. In the preferred embodiment there are three LCD information screens which can be selected by operation of push button (9).

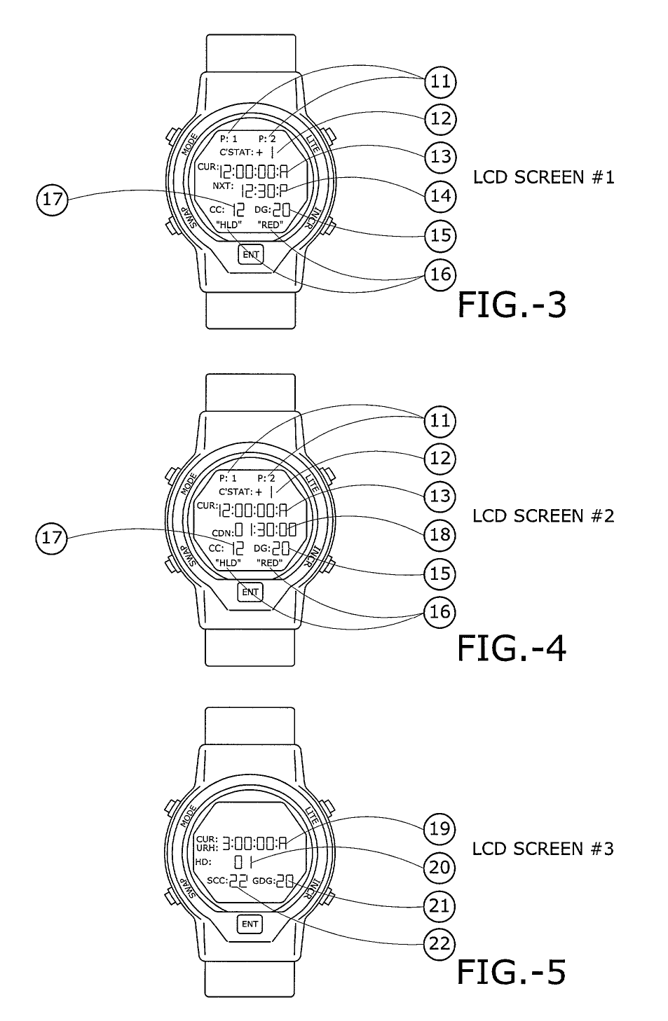

FIG. 3 shows LCD screen #1. This screen could be selected by the user as the normally displayed screen, if they desire.

At LCD screen #1 line (11), the user can see what time period they are currently in. Based on the method programming, and the time elapsed from the start of the day's program, either P:1 will be illuminated to indicate that the user is in Period 1, or P:2 will be illuminated to indicate that the user is in Period 2.

At LCD screen #1 line (12), the user can see their current status (C'STAT). Current status (C'STAT) is a numeric value, indicating whether the user is ahead of (a positive number), behind (a negative number), or equal to (a zero value), the reduction method programming. Current status (C'STAT) is incremented +1 in accordance with the method programming. Current status (C'STAT) is incremented −1, each time a user pushes the “enter” button (7) indicating that a cigarette is being consumed. Current status (C'STAT) is reset to +1 at the unit reset hour (URH).

At LCD screen #1 line (13), the current real time is displayed as in a normal watch.

At LCD screen #1 line (14), the next (NXT) authorized smoking opportunity is displayed as a real time value. The next (NXT) value is calculated and updated automatically by the CPU, in accordance with the reduction method's programming.

At LCD screen #1 line (15), the day's goal value (DG) is displayed. The daily goal (DG) value is the goal number of cigarettes planned to be smoked for the current day. The daily goal (DG) value is calculated and updated automatically by the CPU, in accordance with the reduction method's programming.

At LCD screen #1 line (16), the device in accordance with the method's programming, indicates whether the current day is a hold day (HLD) or a reduction (RED) day, by illuminating either “HLD” or “RED”.

At LCD screen #1 line (17), the device displays the current cigarette count (CC). This value is the current count of all cigarettes smoked thus far in the day. This value is incremented +1 by operation of the “enter” pushbutton (7) acknowledging a smoking event, and is rest to zero by the CPU, at the unit reset hour (URH) in accordance with the method's programming.

FIG. 4 shows LCD screen #2. The user could also select this screen as the normally displayed screen, if they desire. The displayed lines (11, 12, 13, 15, 16, and 17) perform the identical function as described for LCD screen #1.

Line (18) of LCD screen #2, provides a countdown (CDN) timer display. The countdown timer (CDN) display, provides real time information to a user as to when the next authorized smoking opportunity will be. The countdown timer (CDN) resets automatically at 00:00:00, to the calculated incremental values of period 1 or period 2, in accordance with the method's programming controlled by the device CPU.

FIG. 5 shows LCD screen #3. This screen is the programming screen, where a user can enter into the device their individual smoking habit, and their smoking reduction goal.

Line (19) of LCD screen #3, shows the unit-reset hour (URH). The unit-reset hour (URH) is a real-time value programmed by the user at first use. The unit-reset hour (URH) value indicates the time the unit will switch to the start of a new day, which in turn will cause all program values to recalculate and reset for that day's use.

Line (20) of LCD screen #3, shows the hold days (HD) value. The hold days (HD) value is where the user can select the number of days that the method programming will “hold” at intermediate reduction levels.

Line (21) of LCD screen #3, shows the reduction goal (GDG) in units of cigarettes smoked per day. This is where the user enters their overall reduction goal value in units of cigarettes smoked per day.

Line (22) of LCD screen #3, shows the starting cigarette count (SC). The starting cigarette count (SC) is where the user enters the starting number of cigarettes per day that they smoke.

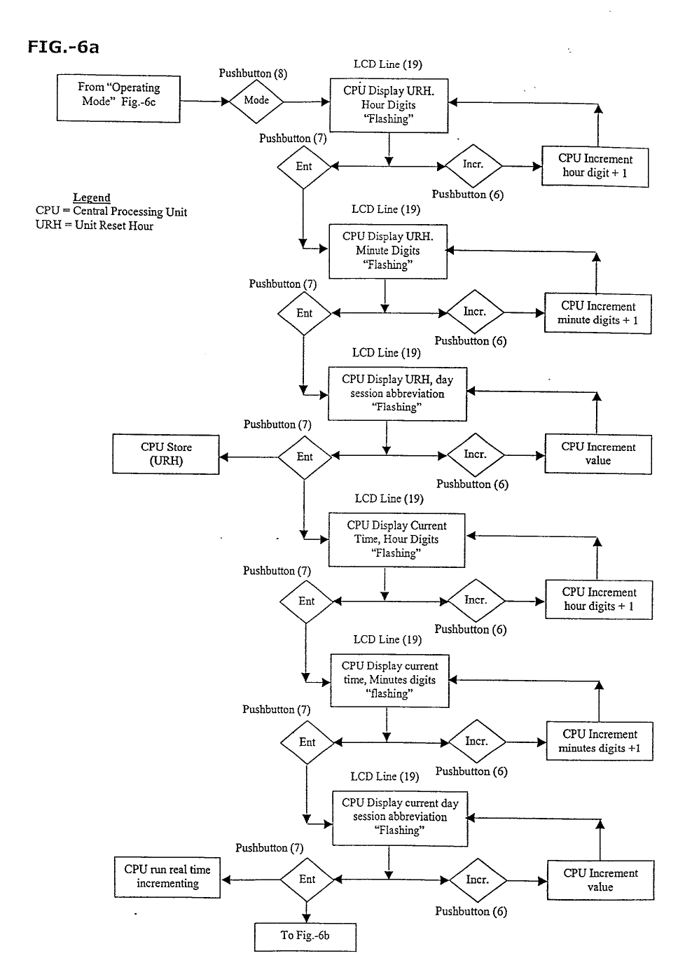

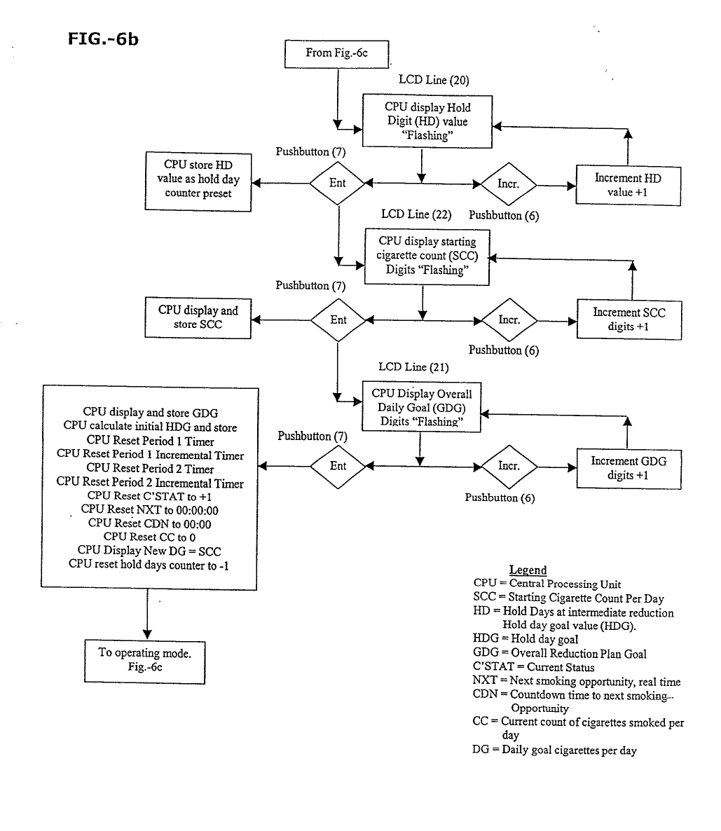

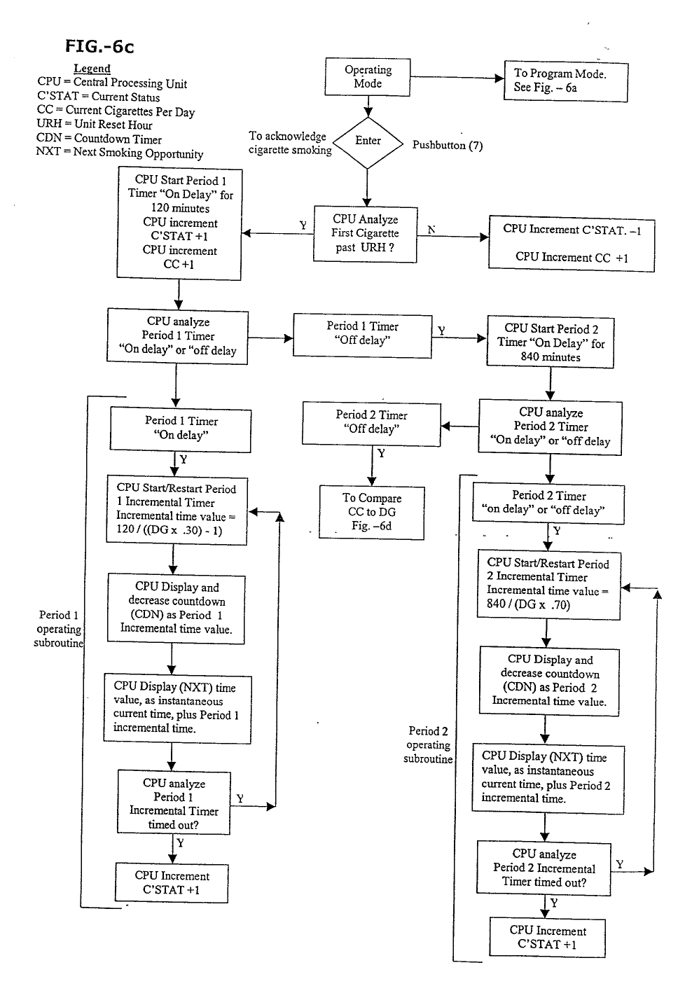

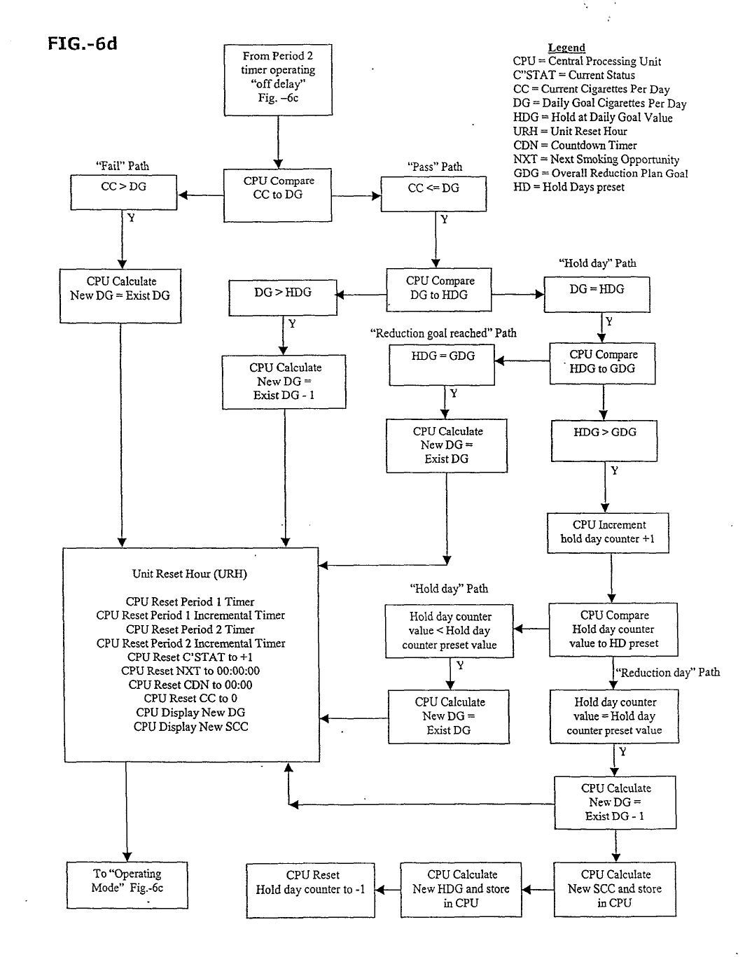

FIGS. 6a, 6b, 6c and 6d show the functional block diagrams for the operating mode, and programming mode of the reduction method's program.

FIG. 6a shows the first steps in programming the device.

Upon activation of pushbutton (8), the device will automatically switch to LCD screen 3, with URH illuminated at LCD line (19), and the hours digits flashing. The user can increment the hour digit value to the required digit value by operation of the “increment” pushbutton (6). The user can accept the hour digit value by operation of the “enter” pushbutton (7). Once the hour digit value has been accepted, the minutes digit value of the URH, at LCD screen 3 line (19), begins flashing. The user can increment the minute digit value, to the required digit value, by operation of the “increment” pushbutton (6). The user can accept the minute digit value, by operation of the “enter” pushbutton (7). Once the minute digit value has been accepted, the day session abbreviation of the URH, at LCD screen 3 line (19), begins flashing. The user can increment the day session abbreviation value to the required value, by operation of the “increment” pushbutton (6). The user can accept the day session abbreviation value, by operation of the “enter” pushbutton (7). Once the day session abbreviation value has been accepted, the unit reset hour (URH) and day session abbreviation are stored in the device CPU, for use by the method's program in the operating mode. Additionally, the unit switches to the current time (CUR) setting at LCD screen #3 line (19), with the hours digit value flashing. The user can increment the hour digit value to the required digit value by operation of the “increment” pushbutton (6). The user can accept the hour digit value by operation of the “enter” pushbutton (7). Once the hour digit value has been accepted, the minute digit value of the current time setting (CUR), at LCD screen 3 line (19), begins flashing. The user can increment the minute digit value to the required digit value, by operation of the “increment” pushbutton (6). The user can accept the minute digit value, by operation of the “enter” pushbutton (7). Once the minute digit value has been accepted, the day session abbreviation of the current time setting (CUR), at LCD screen 3 line (19), begins flashing. The user can increment the day session abbreviation value to the required value, by operation of the “increment” pushbutton (6). The user can accept the day session abbreviation value, by operation of the “enter” pushbutton (7). Once the day session abbreviation value has been accepted, the current time setting and session abbreviation as programmed are run by the device CPU for use by the method's program in the operating mode, and for display at LCD screen 1 and 2 line (19) as required.

FIG. 6b shows the remaining steps in programming the device. After acceptance of the current time settings shown in FIG. 6a, the unit automatically switches to the hold days (HD) setting at LCD screen #3 line (20), with the unit digit value flashing. The user can increment the hold days (HD) digit value to the required digit value, by operation of the “increment” pushbutton (6). The user can accept the hold days (HD) digit value, by operation of the “enter” pushbutton (7). Once the hold days (HD) value has been accepted, the hold days (HD) value is stored by the device CPU, for use by the method's program in the operating mode, and for display at LCD screen 3 line (20) as required. After acceptance of the hold days (HD) settings, the unit automatically switches to the starting cigarette count (SCC) setting at LCD screen #3 line (22), with the unit digit value flashing. The user can increment the starting cigarette count (SCC) digit value to the required digit value, by operation of the “increment” pushbutton (6). The user can accept the starting cigarette count (SCC) digit value, by operation of the “enter” pushbutton (7). Once the starting cigarette count (SCC) value has been accepted, the starting cigarette count (SCC) value is stored by the device CPU for use by the method's program in the operating mode, and for display at LCD screen 3 line (22) as required. After acceptance of the starting cigarette count (SCC) setting, the unit automatically switches to the goal cigarette per day (GDG) setting at LCD screen #3 line (21), with the unit digit value flashing. The user can increment the goal cigarette per day (GDG) digit value to the required digit value by operation of the “increment” pushbutton (6). The user can accept the goal cigarette per day (GDG) digit value, by operation of the “enter” pushbutton (7). Once the goal cigarette per day (GDG) value has been accepted, the goal cigarette per day (GDG) value is stored by the device CPU for use by the method's program in the operating mode, and for display at LCD screen 3 line (21) as required. Additionally once the goal cigarette per day (GDG) value has been entered and accepted, the device is fully programmed and ready to operate in the operational mode.

FIG. 6c shows the operating mode of the device, and more specifically the Period 1, and Period 2, subroutines of the method's programming.

In operation, when a user operates the “enter” button (7) to acknowledge the smoking of a cigarette, the device's CPU analyzes if this is the first operation of the enter pushbutton (7) past the unit reset hour (URH). If it is the first time the enter button is pushed after the unit reset hour (URH) has reset all programming functions, then the CPU starts the period 1 “on delay” timer. The period 1 “on delay” timer continues operation “on delay” until the 120 minute duration of period 1 has timed out. The 120 minute period 1 timer is not displayed by the device, but is merely an internal CPU timer, utilized by the method's programming to track the duration of period 1. Furthermore, the start of period 1 is unrelated to any real time value, period 1 simply commences the first time a user acknowledges the smoking of a cigarette past the unit reset hour (URH). Concurrently with the start of the period 1 timer, the first time the “enter” button (7) is pushed after the unit reset hour (URH), the current count (CC) is incremented +1 digit, and the current status (C'STAT) is incremented −1 digit. This is required because the current count (CC) was reset to 0, and the current status (C'STAT) was reset to +1, at the unit reset hour (URH). Because of this, the device would show +1 at the current count (CC) display LCD screen #1 and #2 line (17), and +0 at the current status (C'STAT) display, LCD screen #1 and #2 line 12, the first time the enter button is pushed after the unit reset hour (URH). This would then indicate that the user is on schedule with the method programming.

If it is not the first time the “enter” button (7) is operated past the unit reset hour (URH), but the second, third, fourth, or so on, then the current status (C'STAT) display is incremented −1, and the current count (CC) display is incremented +1.

As required by the method's program, when push button (7) is operated to acknowledge the first smoking event past the URH, the period 1 120 minute “on delay” timer starts and runs “on delay” for 120 minutes. Immediately upon activation of the period 1 timer, the CPU calculates the period 1 incremental time value utilizing the following formula: Incremental time value=120/((daily goal (DG)×30%)−1). This value represents the period 1 incremental time value between authorized smoking events. This value is expressed in units of hours and minutes, and is stored in the CPU for use by the method's program. Instantaneously, this calculated hour and minute value is displayed at the countdown timer (CDN) of LCD screen 2 line (18), and immediately the CPU begins a real time countdown from this value. Additionally, this calculated period 1 incremental time value is added to the instantaneous current real time and displayed at LCD screen 1 line (14) as next (NXT). When the period 1 incremental timer has timed out, the device CPU will authorize another smoking opportunity. To indicate this, the current status display (C'STAT) at LCD screen #1 and #2 line (12), is incremented +1. Additionally, if the period 1 “on delay” timer is still operating “on delay”, then the countdown timer at LCD screen #2 line (18) is reset to the calculated period 1 incremental time value, and begins anew the countdown. And the calculated period 1 incremental time, is again added to the instantaneous current real time, and displayed at LCD screen #1 line (14) as next (NXT). The subroutine of incremental count down at the countdown timer (CDN) of LCD screen 2 line (18), updating the current real time display of next (NXT) at LCD screen 1 line (14), and incrementing current status (C'STAT) +1 at LCD screens 1 and 2 line (12), continues over and over, until the period 1 “on delay” timer has timed out, and has switched to “off delay”.

When the period 1 “on delay” timer has timed out and switched to “off delay”, this indicates the end of period 1. Instantaneously, the period 2, 840 minute “on delay” timer starts, and runs “on delay” for 840 minutes. Immediately upon activation of the period 2 timer, the CPU calculates the period 2 incremental time value, utilizing the following formula: Period 2 incremental time value=840/(daily goal (DG)×70%). This value is the period 2 incremental time value between authorized smoking events, is expressed in units of hours and minutes, and is stored in the CPU for use by the method's program. Instantaneously, this calculated hour and minute value is displayed at the countdown timer (CDN) of LCD screen 2 line (18), and immediately the CPU begins a real time countdown from this value. Additionally, this calculated period 2 incremental time value is added to the instantaneous current real time and displayed at LCD screen 1 line (14) as next (NXT). When the period 2 incremental timer has timed out, the current status display (C'STAT) at LCD screen #1 and #2 line (12), is incremented +1. Additionally, the countdown timer (CDN) at LCD screen #2 is reset to the calculated period 2 incremental time value and the CPU begins anew the countdown. Likewise, the calculated period 2 incremental time, is again added to the instantaneous current real time, and displayed at LCD screen #1 line (14) as next (NXT). The period 2 subroutine of incremental count down at the countdown timer (CDN) of LCD screen 2 line (18), updating the current real time display of next (NXT) at LCD screen 1 line (14), and incrementing current status (C'STAT) +1 at LCD screens 1 and 2 line (12), continues over and over, until the period 2 timer has been reset by the current time reaching the unit reset hour (URH). When the period 2, 840 minute “on delay” timer has timed out, the status of the timer switches to “off delay”, this signals to the device CPU the end of a daily routine.

FIG. 6d shows the analytical functions preformed by the device CPU at the end of a daily subroutine in accordance with the method programming.

The first analytical function preformed by the CPU, is to considered if the user “passed” or “failed” the daily method program. This is determined, by comparing the current count (CC) to the daily goal (DG). The user has “failed” the daily method programming if the current count (CC) is greater than the daily goal (DG). The user has “passed” the daily method programming if the current count (CC) is less than or equal to the daily goal (DG).

If the user has “failed” the daily method programming, the CPU reestablishes the new daily goal (DG) as the existing daily goal (DG). The device then waits for the unit reset hour (URH) to reset all functions to the same daily values as before.

If the user has “passed” the daily method programming by having a current count (CC) equal to or less than the daily goal (DG), then another comparison is preformed by the device CPU. This comparison is to determine whether the next day of the method programming will be a “reduction” day, or a “hold” day. This comparison consists of comparing the daily goal (DG) to the hold day goal (HDG). The hold day goal (HDG) is a numeric value that is calculated and stored in the CPU when the user first programs the device. The hold day goal (HDG) is the intermediate reduction goal where the reduction method requires an individual to hold for the number of days that were initially programmed into the device at the hold days (HD) value. The hold days goal is determined by the CPU utilizing the following equation: hold day goal (HDG)=starting cigarette count “SCC”−((starting cigarette count “SCC”−goal cigarettes per day “GDG”)×30%).

If the daily goal (DG) to the hold day goal (HDG) comparison, shows that the daily goal (DG) is greater than the hold day goal (HDG), then a reduction day is required. The CPU then calculates the new daily goal (DG) value utilizing the following equation: New daily goal (DG)=existing daily goal (DG)−1. This allows for a one-cigarette reduction for the next day's method routine. After this calculation, the device then waits for the unit rest hour (URH) to reset all values for the next day's use.

If the daily goal (DG) to the hold day goal (HDG) comparison, shows that the daily goal (DG) is equal to the hold day goal (HDG), then a hold day is required per the reduction method's program. When a hold day (HD) is required, the CPU will increment the hold day incremental counter 1 unit value. At this point, the CPU will then compare the current incremental count value of the hold day counter, to the preset value of the hold day counter. (The preset value of the hold day counter, will be the value programmed by the user at hold days (HD). This value represents the number of days the user wishes to hold at the intermediate reduction value) If this comparison shows that the current count of the hold day counter, is less than the hold day counter preset value, then an additional hold day is required. If a hold day is required, the CPU establishes the new daily goal (DG) as equal to the existing daily goal (DG). After this calculation, the device then waits for the unit rest hour (URH) to reset all values for the next day's use.

When this comparison shows that the current count of the hold day counter, is equal to the hold day counter preset value, then the CPU will establish that the hold day period has been successfully completed, and a reduction day is now required. The CPU will then calculate the new daily goal (DG) utilizing the following equation: New daily goal (DG)=existing daily goal (DG)−1. This allows for a one-cigarette reduction for the next day's method routine. Additionally, after successfully completing the hold days required by the method's programming, the CPU will reset the hold days counter to −1, will reset the starting cigarette count value (SCC) to equal the current hold day goal value, and recalculate and store a new hold day goal value (HDG) utilizing the equation for determining hold day goal (HDG). The device then waits for the unit rest hour (URH) to reset all values for the next days use.

At the unit reset hour (URH) that was programmed by the user at first use, the following functions are preformed by the CPU to ready the device for a new daily routine: the current status (C'STAT) display is reset to +1, the current count (CC) display is reset to 0, the daily goal (DG) value is updated per the disposition of the analytical functions preformed at the end of the daily routine just passed, the countdown timer (CDN) and next (NXT) time values are reset to 00:00:00, the starting cigarette count (SCC) is updated to the new starting cigarette count (SCC) value if required, and the period 1 and 2 timers are reset.

This entire subroutine continues over and over, daily, until the goal cigarettes per day (GDG) value is attained, at which point the device works to hold the user at that value.

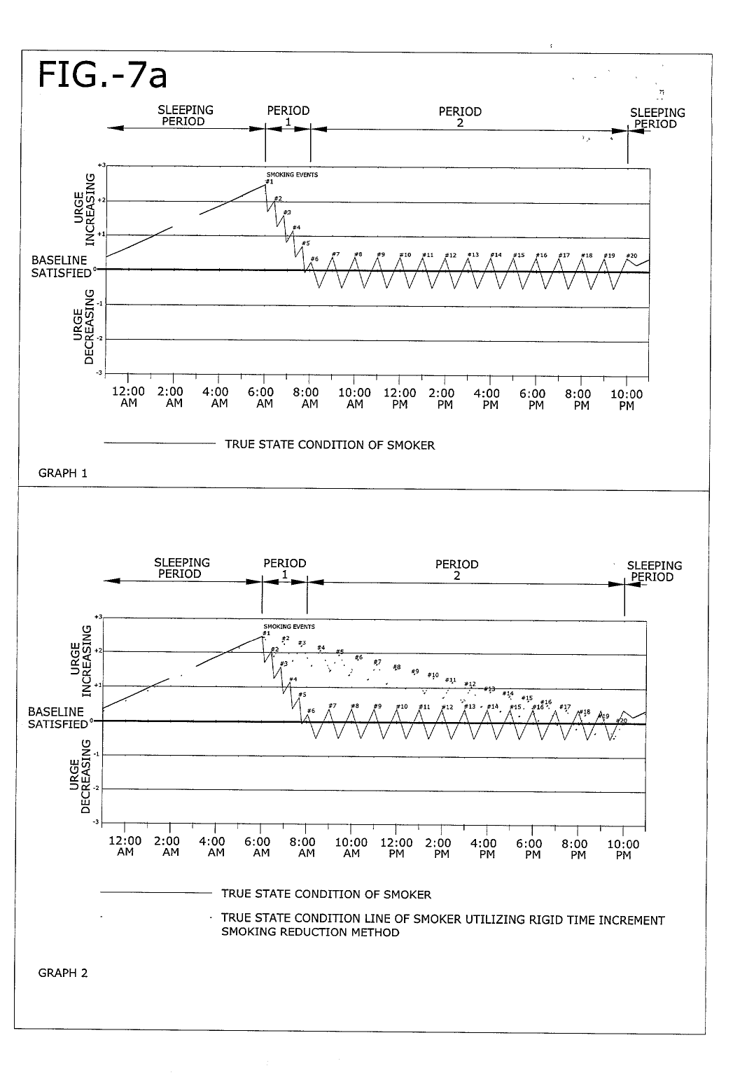

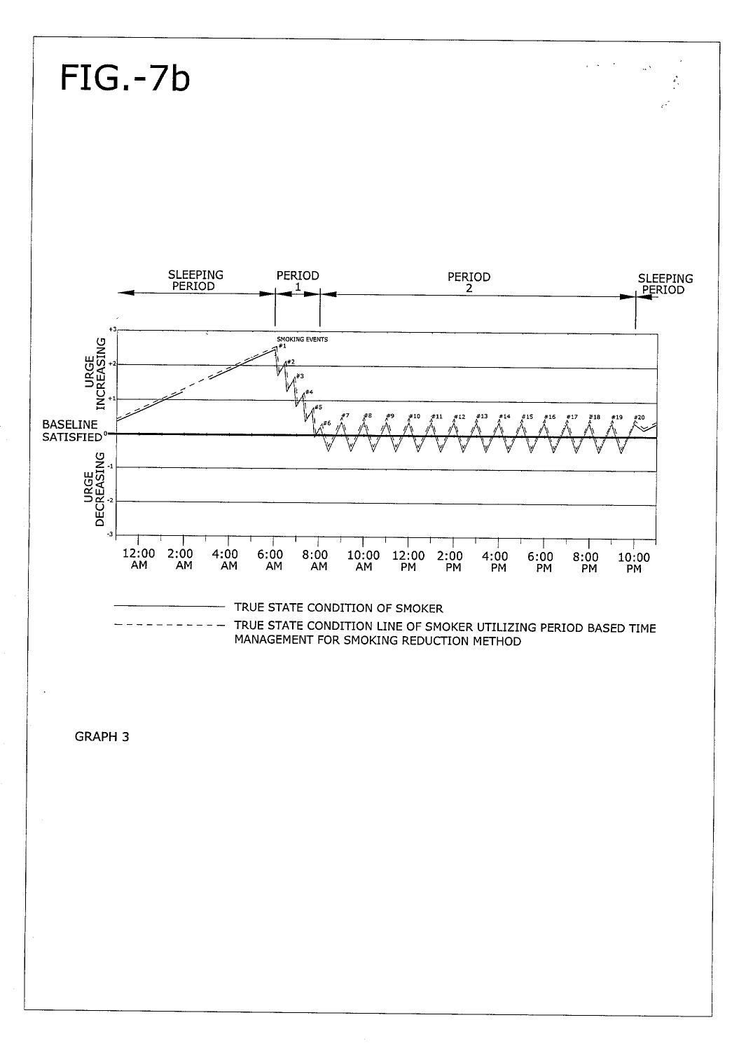

FIGS. 7a and 7b show graphically the differences between the present invention's “period” based incremental reduction method, and the “rigid” time incremental reduction methods of the prior art contained in U.S. Pat. Nos. 3,999,412; 4,076,118; 4,620,555; 4,615,681; 4,862,431; 5,203,472; 5,566,855; 5,778,897; 6,125,082; 4,311,448; and 4,853,854. In FIG. 7a, graph 1 shows what the present invention claims to be the relationship between the smoking urge and time, over the course of a normal day. The heavy solid horizontal line, shows the “base line”, which is the smokers “desired” condition. The light solid line shows the “true state” of a smoker as claimed by the present invention. The difference between the two lines is what the present invention claims as the “urge intensity”. The present invention contends, that the greater the difference, the greater the “urge intensity”. Furthermore, the present invention claims that there are three distinctly different time periods were the “urge” to smoke is plainly different. The present invention categorizes and defines these different time periods, and graph 1 shows these as follows:

Sleeping Period:

During this time period, the urge to smoke is increasing, however, in most smokers this urge is defeated, by the simple fact that they are sleeping.

Period 1:

The present invention defines this period as a period of time upon first awakening. During this time period, it is an assertion of the present invention, that the urge to smoke is greater than the urge to smoke in the second time period, as the user is trying to achieve what they perceive as their normal nicotine level. The present invention contends that in period 1, a smoker will smoke more cigarettes per unit time, relative to period 2, to make up for the lost nicotine level caused by the nights sleep. The present invention contends that smoking needs to be increased within this time period relative to the following period 2.

Period 2

The present invention defines this period, as the hours between period 1 and the sleeping period. It is claimed by the present invention that during this time period, with the ramp up requirements of period 1 satisfied, smoking can be managed on a more even basis, given a routine day.

With the user baseline and true state conditions established by graph 1, Graph 2 of FIG. 7a, shows the delivery of smoking opportunities by the “rigid” time methods employed by U.S. Pat. Nos. 3,999,412; 4,076,118; 4,620,555; 4,615,681; 4,862,431; 5,203,472; 5,566,855; 5,778,897; 6,125,082; 4,311,448; and 4,853,854. It is important to note that the method employed by this art, is “rigid” time increment management. What “rigid” time increment management means, is that a 20 cigarette per day smoker for example, would start these programs with an allotment of 1 cigarette per 50 minutes if one assumes a 16 hour day. When a reduction is required, the time increment will be changed to a higher value, however, it will be the same “rigid” for the entire day.

Graph 2, again shows the baseline satisfied condition for a smoker, and the “true state” of the smoker as contended by the present invention. The dotted line shows the true state of a user utilizing “rigid” time increments for delivery of smoking opportunities. As can be seen, the difference between the “baseline” satisfied condition, and the “true state” of a user utilizing “rigid” time increment smoking management, is not satisfied until the end of the day. The present invention contends that this is because the ramp up period of period 1 to the desired condition, was not allowed by the “rigid” time increment delivery method. This fact will produce “urges” all day long for the “rigid” time incremental device user.

FIG. 7b presents graphically the present invention's “period” based method. Notice that because of time period management, with differing time increment values, the “true state” of the user is more quickly moved to the desired condition. For this reason the present invention's method will produce less withdrawal symptoms, and the withdrawal symptoms that are produced will be less sever than with devices utilizing “rigid” time increment management.

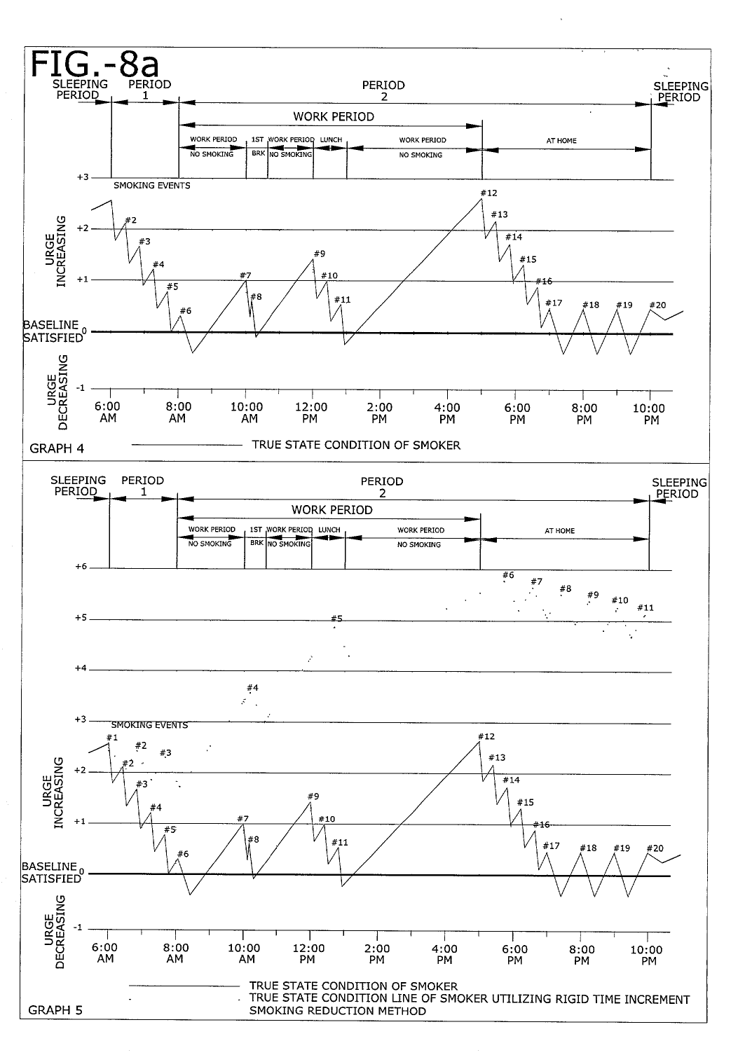

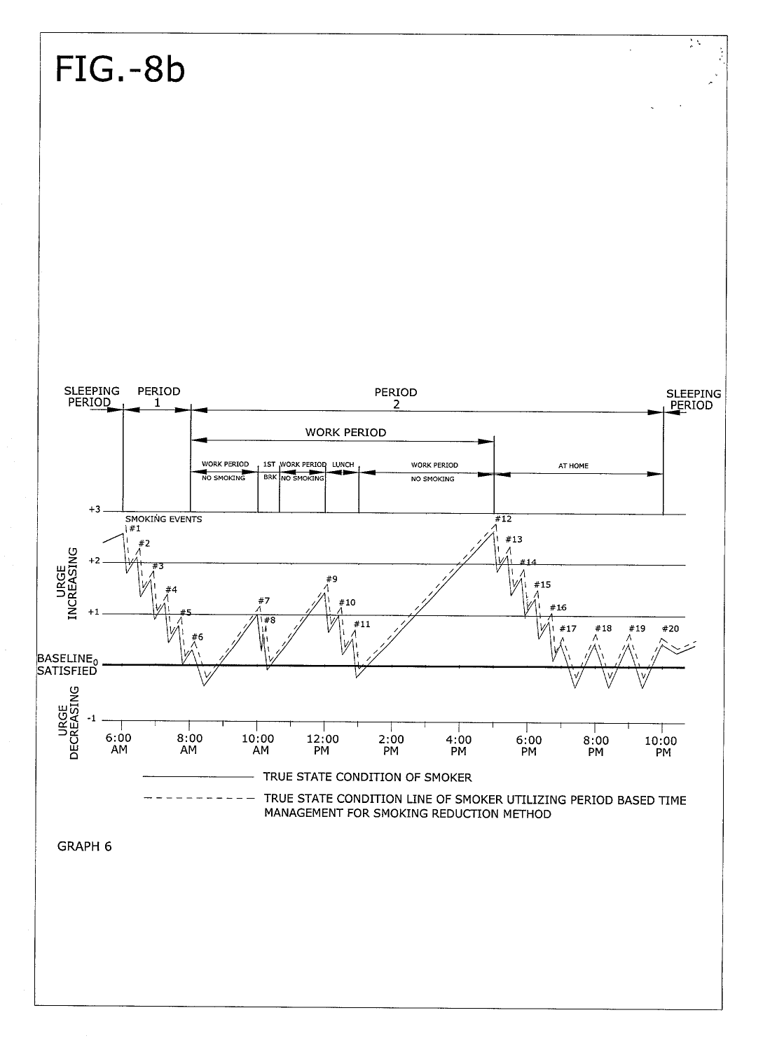

FIGS. 8a and 8b presents graphs to show how the present invention's method can manage other time periods in addition the minimum periods 1 and 2. And uses an example to again illustrate the present invention's method compared to the prior art using “rigid” time management.

For the purpose of illustration and comparison only, consider the following user information: The user is a 20 cigarette per day smoker (1 pack), who works 8:00 am to 5:00 pm where smoking is prohibited except during the morning break at 10:00 to 10:15 am, and lunch time at 12:00 to 1:00 pm. This smoker rises at 6:00 am and retires at 10:00 pm.

Graph 4 of FIG. 8a, presents what the present invention claims to be the true state of this smoker with respect to the baseline for the day used in the example. Again, the baseline is the user's satisfied condition. As can be seen by the graph, the user awakens to a strong urge to smoke, and smokes a quantity of cigarettes that returns them to the baseline where they feel satisfied. Once at work where smoking is prohibited, the urge to smoke is increasing because the bodily nicotine level is decreasing. At the users first break period, smoking is again “heavy” on a cigarette per unit time basis, as the user wishes to replenish their lost nicotine level, and in anticipation of the next work period where smoking is prohibited. Again in the next work period, the urge to smoke is increasing because the bodily nicotine level is decreasing. At lunchtime, the smoker again smokes heavily on a cigarette per unit time basis, to replenish their lost nicotine level and return their body to what it perceives as a state of satisfaction. In the afternoon work session, again the urge to smoke is increasing because the bodily nicotine level is falling. Once out of work, where the no-smoking requirements are gone, the user can return their body to what it considers satisfied, and maintain this satisfied condition by smoking a cigarette in response to an increasing urge.

Graph 5 of FIG. 8a, graphically shows again the problems with “rigid” time increment, utilized for a smoking reduction method. If we assume that the 20 cigarette per day smoker in the example will start the reduction program at 20 cigarettes, the incremental time value can be calculated as 50 minutes between smoking events. This translates to a smoking schedule of 6:00 am 6:50 am, 7:40 am 8:30 am,9:20 am, 10:10 am, 11:00 am, 11:50 am, 12:40 pm, 1:30 pm, 2:20 pm, 3:10 pm, 4:00 pm, 4:50 pm, 5:40 pm, 6:30 pm, 7:20 pm, 8:10 pm, 9:00 pm and 9:50 pm. If we look at these smoking opportunities graphically as they occur during the users day, we find that the user is given their 6:00, 6:50 and 7:40 am smoking opportunities, but will then miss their 8:30 and 9:20 am smoking opportunity because of their work rules. This user will then receives their 10:10 am cigarette during their first break, but then miss their, 11:00 and 11:50 am cigarettes because of their work rules. They receive their 12:40 pm cigarette break during lunchtime, but then miss their scheduled cigarettes at 1:30, 2:20, 3:10, 4:00 and 4:30 pm, again because of work rules. After their workday, this user could then finish out their planned cigarettes at 4:50, 5:40, 6:30, 7:20, 8:10, 9:00 and 9:50. As shown, this rigid incremental method provided only 11 cigarettes to the user in this example. The problem with this method and these limiting type devices, are that they do not provide for the requirements of the user. They do not take into consideration that the level of smoking in a smoker varies depending on the smoker's current situation.

FIG. 8b presents graph 6 to show how the present invention's reduction method would handle the user in the example. Per the present invention's reduction method, the period 1 and period 2 allotments can be calculated at 6 cigarettes for period 1, and 14 cigarettes for period 2, for an overall starting value of 20 cigarettes per day. For the example user utilizing the present invention, they would be allotted cigarettes at 6:00 am, 6:24 am, 6:48 am, 7:12 am, 7:36 am and 8:00 am for period 1. In period 2 the user would be allotted cigarettes at 9:00 am, 10:00 am, 11:00 am, 12:00 pm, 1:00 pm, 2:00 pm, 3:00 pm, 4:00 pm, 5:00 pm, 6:00 pm, 7:00 pm, 8:00 pm, 9:00 pm and 10:00 pm respectively. As shown on graph 6, because of the increased allotment within period 1, the user is returned to the baseline “satisfied” condition prior to starting their workday. Because the method credits cigarettes not smoked by simply incrementing the C'STAT display +1 every time an authorized smoking opportunity occurs, when the user goes to their first break at 9:15, they will have a credited allotment of 2 cigarettes because of their missed smoking opportunities at 9:00 am and 10:00 am. The device will not tell them how to apportion these two cigarettes during their 15 minute break, it will simply tell them that they can smoke two cigarettes and be “on schedule” with respect to the reduction method programming. When they arrive at their lunch hour, again they will have a credited allotment of three cigarettes, because of missed but credited smoking opportunities, at 10:00 am, 11:00 am and 12:00 pm. Again, the device will not indicate how they should apportion these cigarettes during their lunch hour, but will simply indicate that they can smoke 3 cigarettes and still be on the reduction schedule. When their workday is over at 5:00 pm, again they will have a credited allotment of five cigarettes because of the missed smoking opportunities at 1:00 pm, 2:00 pm, 3:00 pm 4:00 pm and 5:00 pm. As claimed by the present invention, they will need these five smoking opportunities to return themselves to what they perceive as “satisfied”. Once this satisfied state is attained, they will be able to finish the daily allotments at 6:00 pm, 7:00 pm, 8:00 pm, 9:00 pm and 10:00 pm on a more regularized schedule assuming their evening remains constant. As shown by this example, the user of the present invention's method was provided the full 20 cigarette allotment. When a reduction to 19 cigarettes per day is required, the user of the present invention's method again will be provided this full allotment. The only difference they will see is an increase in the time interval value caused by the reduction of one cigarette in one of the smoking periods that they experience.

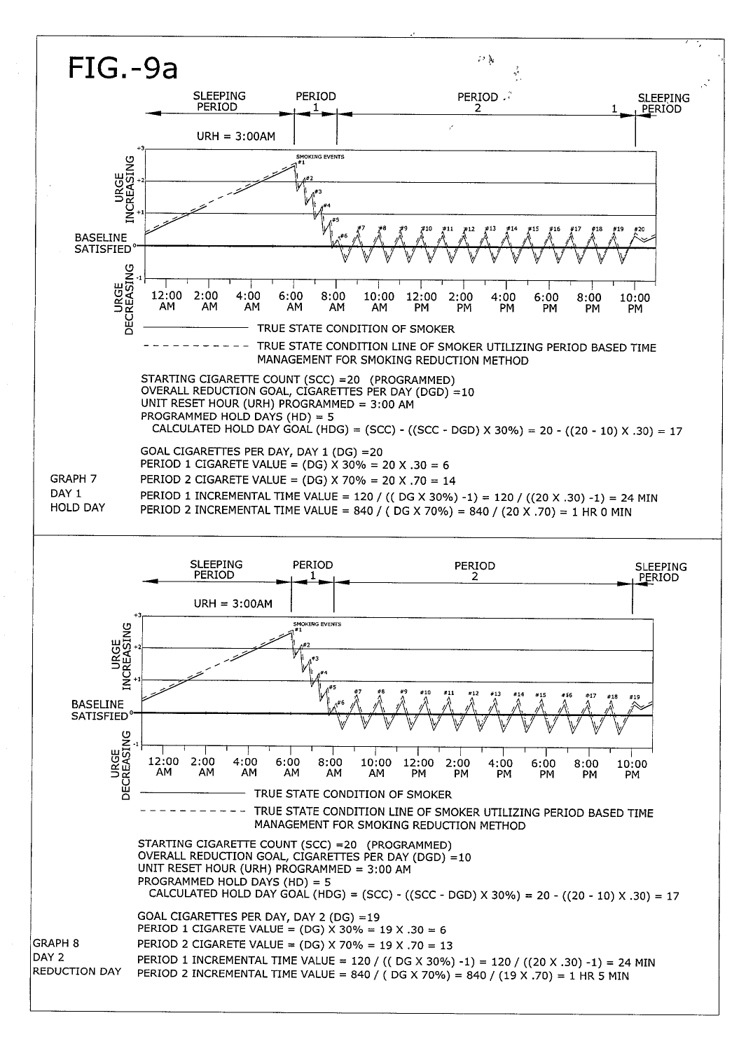

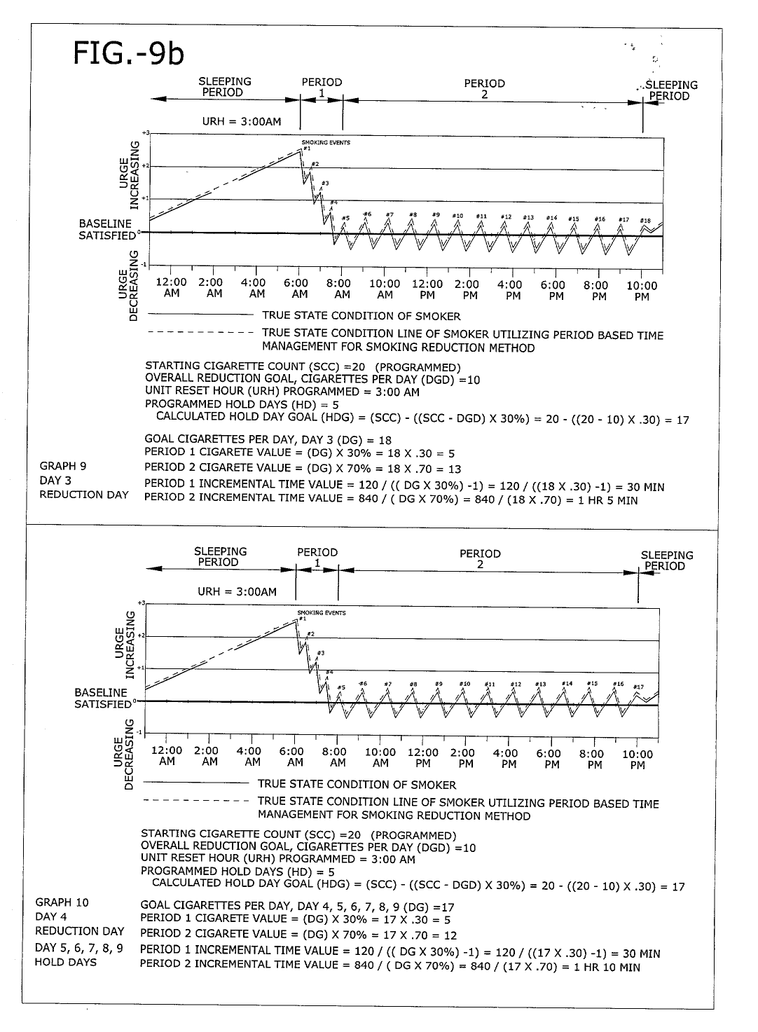

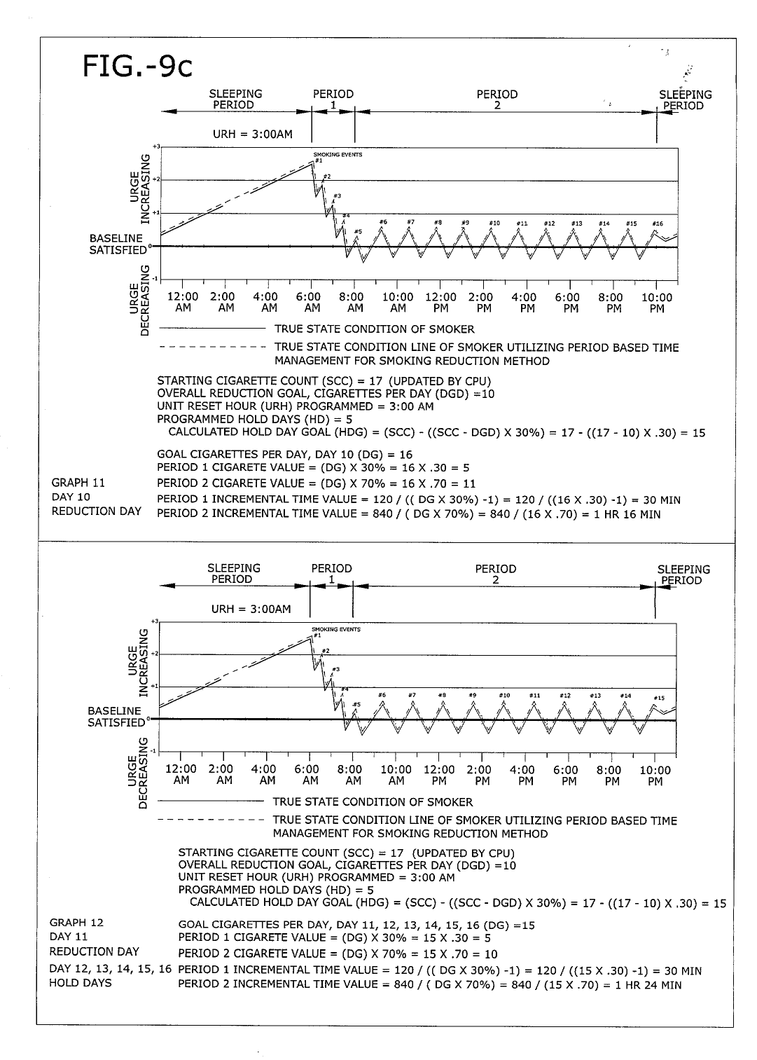

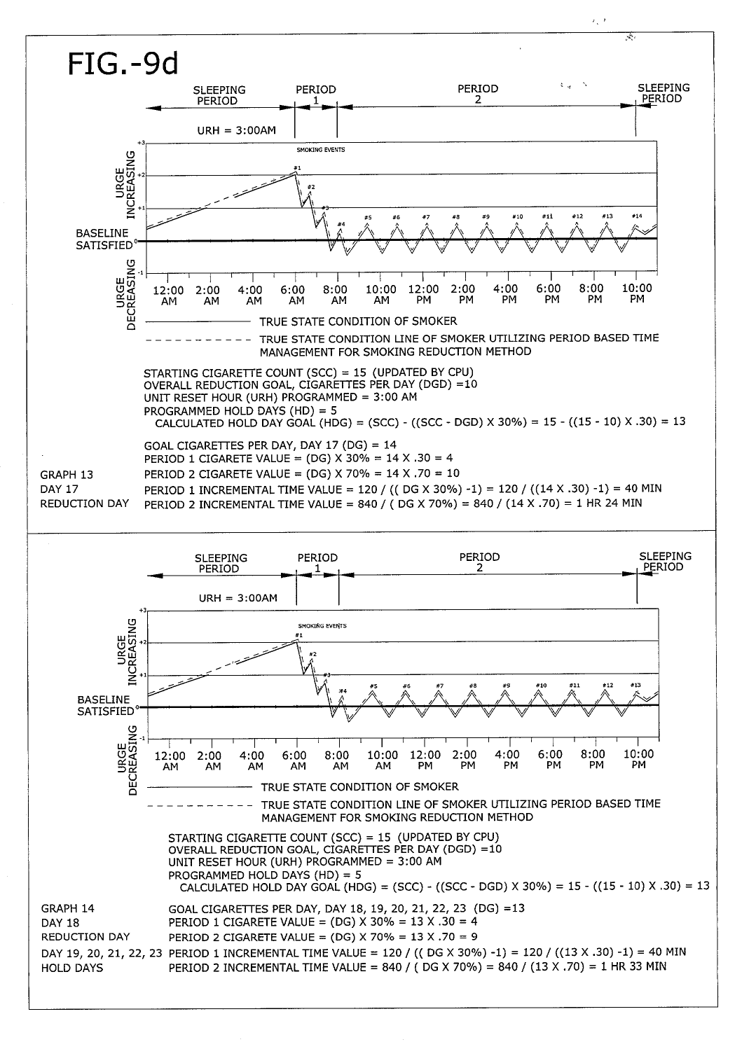

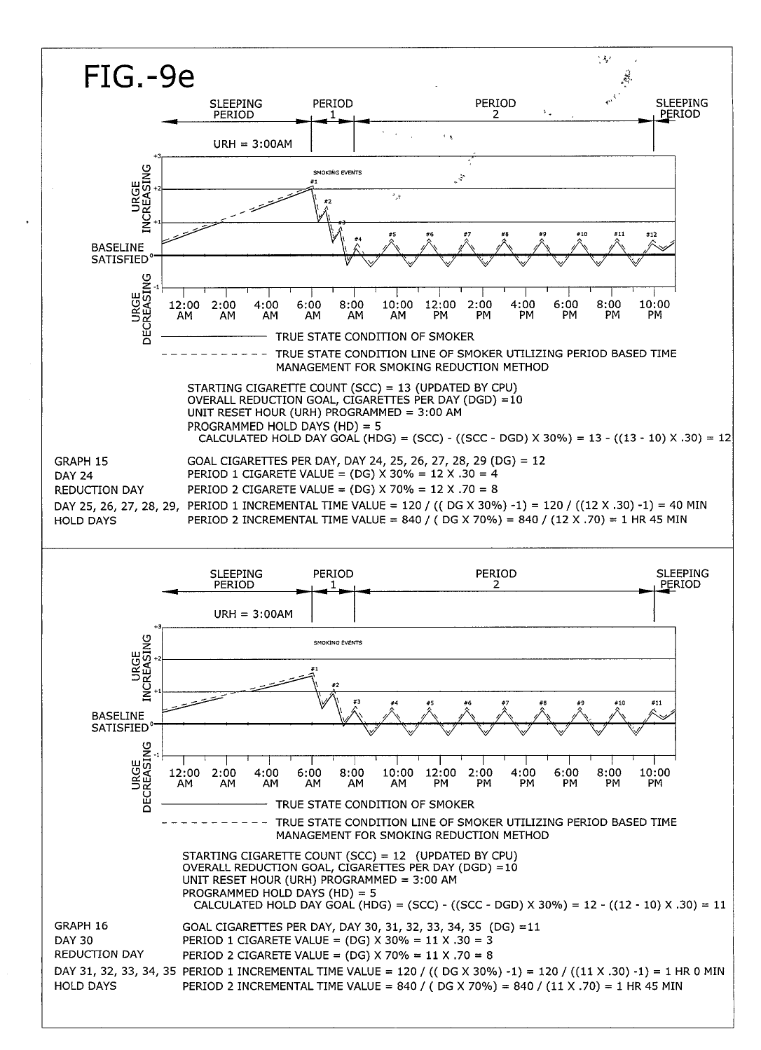

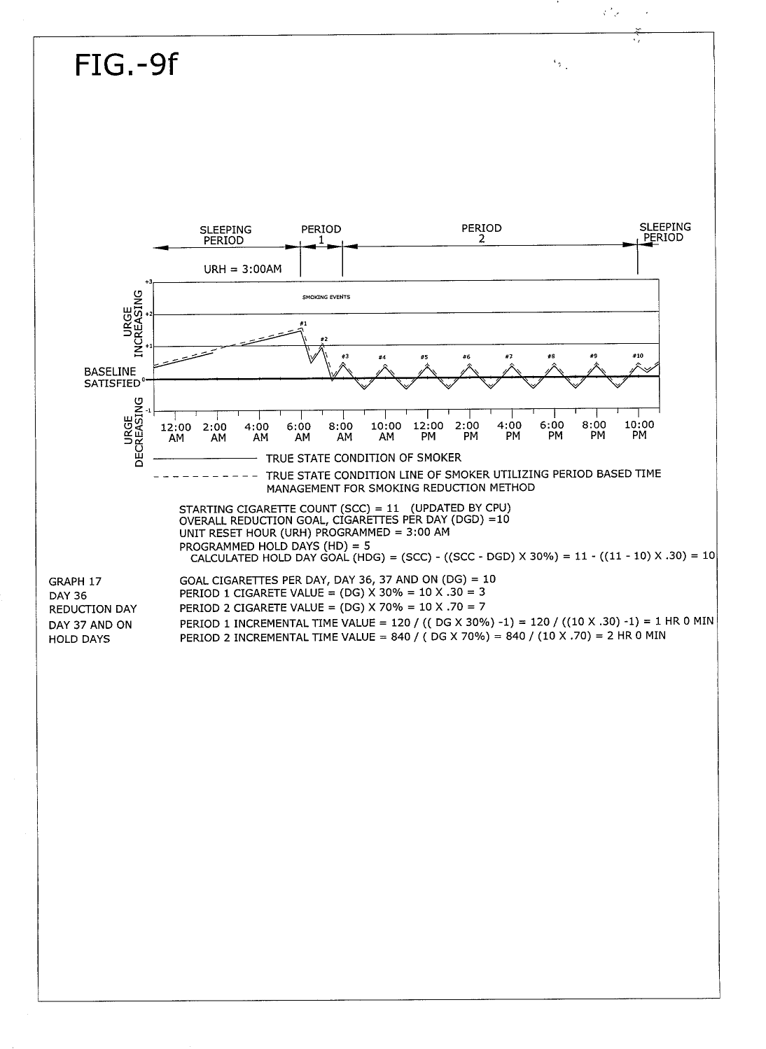

FIGS. 9a, 9b, 9c, 9d, 9e and 9f, show graphs 7 through 17, which demonstrate the present inventions period based reduction method curve in its simplest form. For the purpose of the presentation only, the graphs show a user with the following characteristics: rises at 6:00 am, retires at 10 pm, has initially programmed the device at a starting cigarette count (SCC) of 20, a goal reduction cigarette count (GDG) of 10, a unit reset hour (URH) of 3:00 am and a hold days (HD) value of 5 days.

Graphs 7 through 17, show the “baseline satisfied” condition for this user as the heavy solid horizontal line. The light solid line indicates the “true state” condition of the example smoker, while the light dash-dot line shows the “true state” condition of the smoker utilizing the present inventions period based time management smoking reduction method.

Graph 7 present the Day 1 values encountered by the example user. These values include:

Day 1 hold day goal (HDG)=17

Day 1 goal cigarettes per day (DG)=20

Period 1 cigarette count=6

Period 2 cigarette count=14

Period 1 incremental time value=0 hr 24 min

Period 2 incremental time value=1 hr 0 min

Graph 8 present the Day 2 values encountered by the example user. These values include:

Day 2 hold day goal (HDG)=17

Day 2 is a reduction day, goal cigarettes per day (DG)=19. (Because DG>HDG)

Period 1 cigarette count=6

Period 2 cigarette count=13

Period 1 incremental time value=0 hr 24 min

Period 2 incremental time value=1 hr 5 min

Graph 9 present the Day 3 values encountered by the example user. These values include:

Day 3 hold day goal (HDG)=17

Day 3 is reduction day, goal cigarettes per day (DG)=18. (Because DG>HDG)

Period 1 cigarette count=5

Period 2 cigarette count=13

Period 1 incremental time value=0 hr 30 min

Period 2 incremental time value=1 hr 5 min

Graph 10 present the Day 4, 5, 6, 7, 8, 9 values encountered by the example user. These values include:

Day 4, 5, 6, 7, 8, 9 hold day goal (HDG)=17

Day 4, 5, 6, 7, 8, 9 are hold days, goal cigarettes per day (DG)=17 (Because HDG=DG)

Period 1 cigarette count=5

Period 2 cigarette count=12

Period 1 incremental time value=0 hr 30 min

Period 2 incremental time value=1 hr 10 min

Graph 11 present the Day 10 values encountered by the example user. These values include:

Day 10 hold day goal (HDG)=15

Day 10 is a reduction day, goal cigarettes per day (DG)=16 (Because DG>HDG)

Period 1 cigarette count=5

Period 2 cigarette count=11

Period 1 incremental time value=0 hr 30 min

Period 2 incremental time value=1 hr 16 min

Graph 12 present the Day 11, 12, 13, 14, 15, 16 values encountered by the example user. These values include:

Day 11, 12, 13, 14, 15, 16 hold days goal(HDG)=15

Day 11, 12, 13, 14, 15, 16 are hold days, goal cigarettes per day (DG)=15 (Because DG=HDG)

Period 1 cigarette count=5

Period 2 cigarette count=10

Period 1 incremental time value=0 hr 30 min

Period 2 incremental time value=1 hr 24 min

Graph 13 present the Day 17 values encountered by the example user. These values include:

Day 17 hold day goal (HDG)=13

Day 17 is a reduction day, goal cigarettes per day (DG)=14 (Because DG>HDG)

Period 1 cigarette count=4

Period 2 cigarette count=10

Period 1 incremental time value=0 hr 40 min

Period 2 incremental time value=1 hr 24 min

Graph 14 present the Day 18, 19, 20, 21, 22, 23 values encountered by the example user. These values include:

Day 18, 19, 20, 21, 22, 23 hold day goal (HDG)=13

Day 18, 19, 20, 21, 22, 23 are hold days, goal cigarettes per day (DG)=13 (Because DG=HDG)

Period 1 cigarette count=4

Period 2 cigarette count=9

Period 1 incremental time value=0 hr 40 min

Period 2 incremental time value=1 hr 33 min

Graph 15 present the Day 24, 25, 26, 27, 28, 29 values encountered by the example user. These values include:

Day 24, 25, 26, 27, 28, 29 hold day goal (HDG)=12

Day 24, 25, 26, 27, 28, 29 are hold days, goal cigarettes per day (DG)=12 (Because DG=HDG)

Period 1 cigarette count=4

Period 2 cigarette count=8

Period 1 incremental time value=0 hr 40 min

Period 2 incremental time value=1 hr 45 min

Graph 16 present the Day 30, 31, 32, 33, 34, 35 values encountered by the example user. These values include:

Day 30, 31, 32, 33, 34, 35 hold day goal (HDG)=11

Day 30, 31, 32, 33, 34, 35 are hold days, goal cigarettes per day (DG)=11 (Because DG=HDG)

Period 1 cigarette count=3

Period 2 cigarette count=8

Period 1 incremental time value=1 hr 0 min

Period 2 incremental time value=1 hr 45 min

Graph 17 present the Day 36 and on values encountered by the example user. These values include:

Day 36 and on hold day goal (HDG)=10

Day 36 and on are hold days, goal cigarettes per day (DG)=10 (Because DG=HDG=GDG)

Period 1 cigarette count=3

Period 2 cigarette count=7

Period 1 incremental time value=1 hr 0 min

Period 2 incremental time value=2 hr 0 min

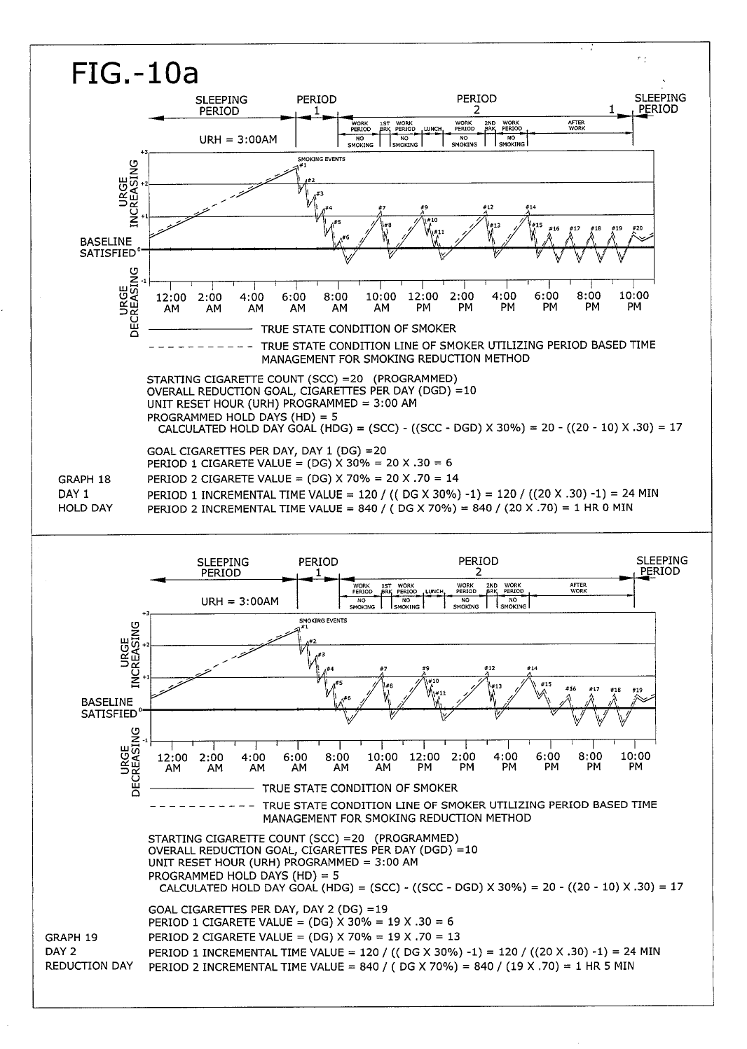

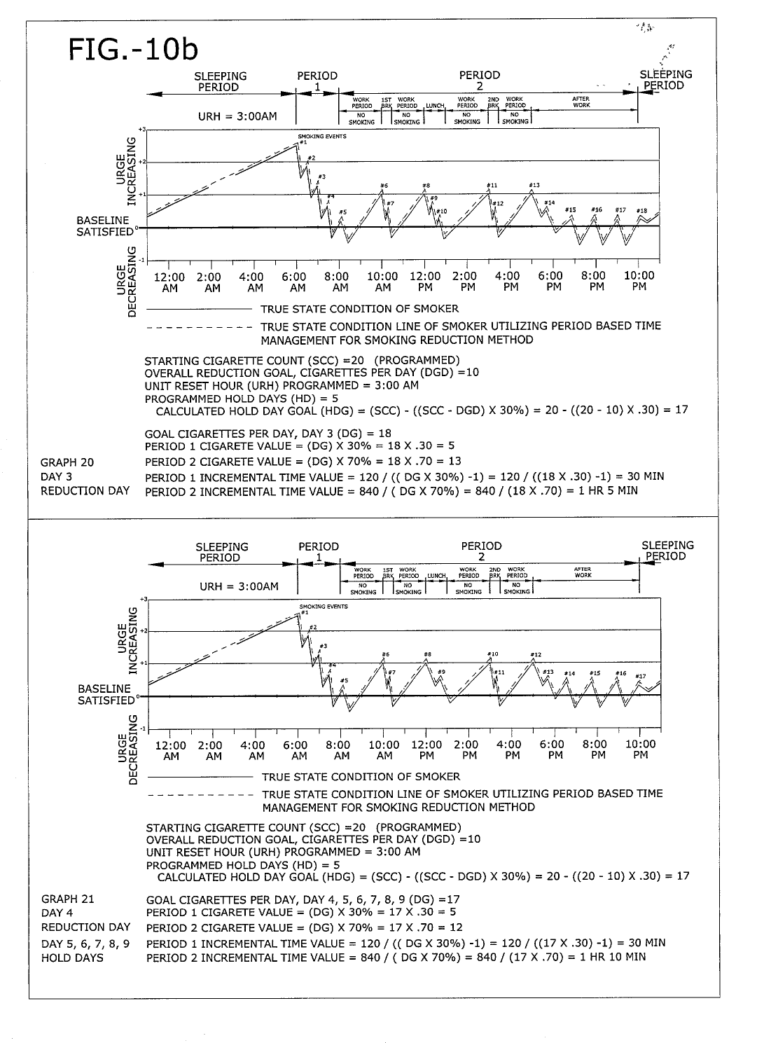

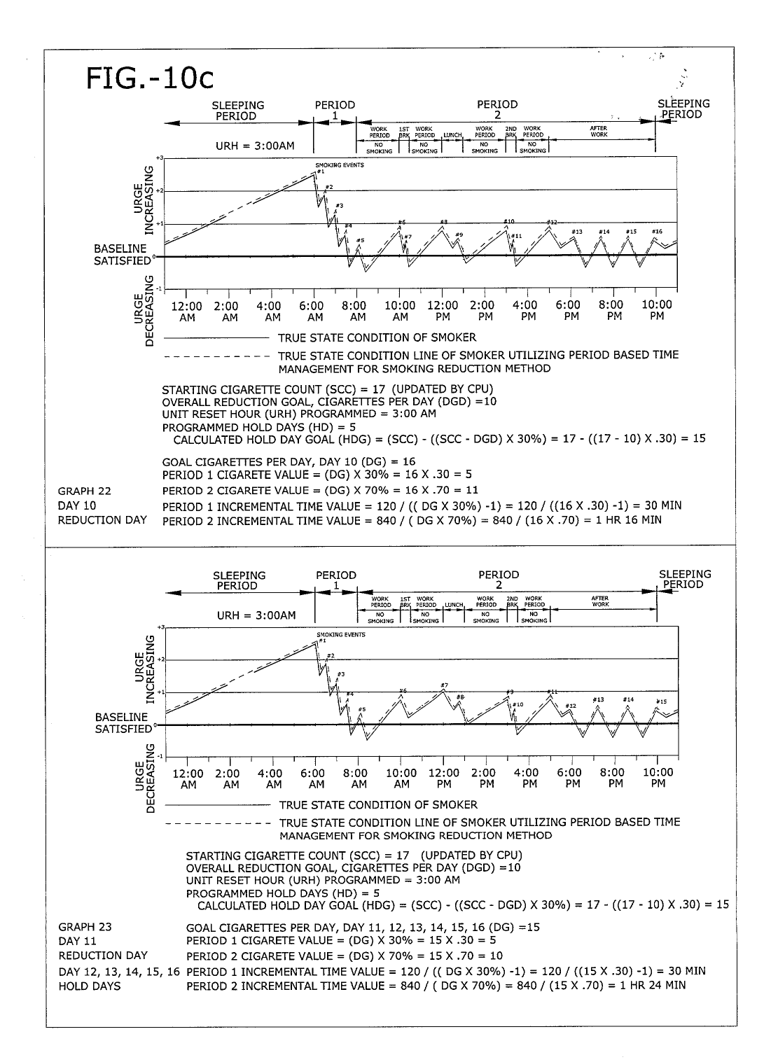

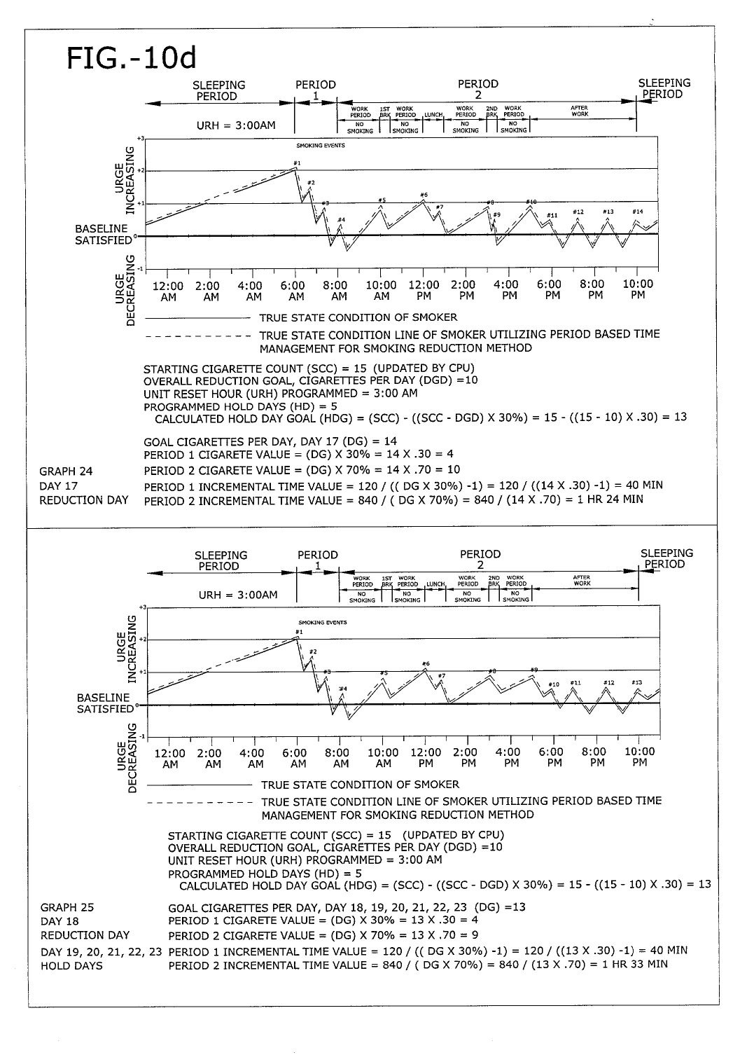

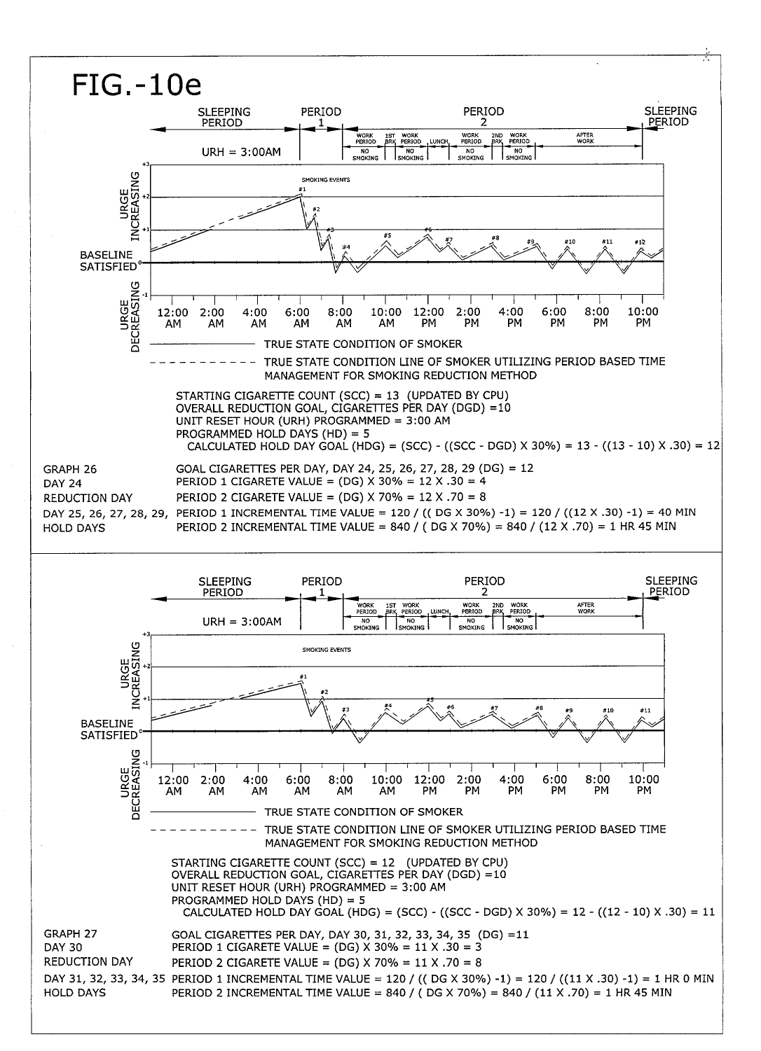

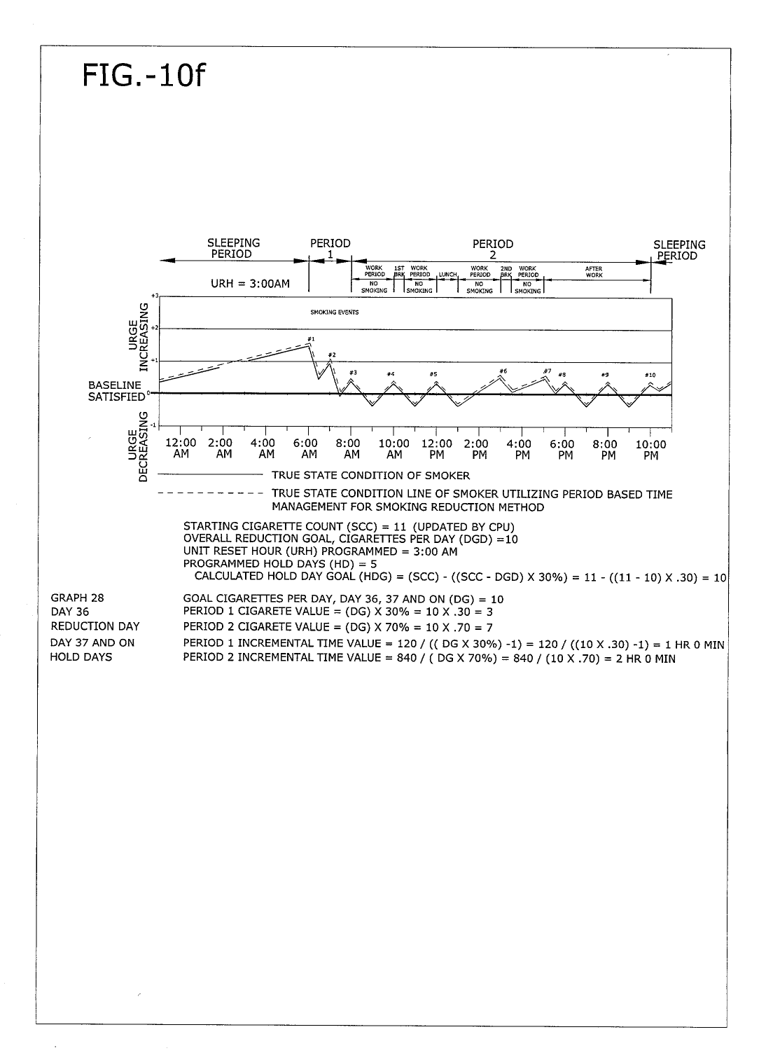

FIGS. 10a, 10b, 10c, 10d, 10e and 10f, show graphs 18 through 28, which demonstrate the present inventions period based reduction method curve in a more sophisticated form. For the purpose of the presentation only, the graphs show a user with the following characteristics: rises at 6:00 am, retires at 10 pm, works 8:00 am to 5:00 pm where smoking is not allowed except during breaks at 10:00 am to 10:15 am, and 3:00 pm to 3:15 pm, and lunch hour at 12:00 pm to 1:00 pm. The user has initially programmed the device at a starting cigarette count (SCC) of 20, a goal reduction cigarette count (GDG) of 10, a unit reset hour (URH) of 3:00 am and a hold days (HD) value of 5 days.

Graphs 18 through 28, show the “baseline satisfied” condition for this user as the heavy solid horizontal line. The light solid line indicates the “true state” condition of the example smoker, while the light dash-dot line shows the “true state” condition of the smoker utilizing the present inventions period based time management smoking reduction method.

These graphs are intended to show how the present invention can manage numerous periods of smoking and non-smoking, contained within the minimum two time periods.

Graph 18 present the Day 1 values encountered by the example user. These values include:

Day 1 hold day goal (HDG)=17

Day 1 goal cigarettes per day (DG)=20

Period 1 cigarette count=6

Period 2 cigarette count=14

Period b 1 incremental time value=0 hr 24 min

Period 2 incremental time value=1 hr 0 min

Graph 19 present the Day 2 values encountered by the example user. These values include:

Day 2 hold day goal (HDG)=17

Day 2 is a reduction day, goal cigarettes per day (DG)=19. (Because DG>HDG)

Period 1 cigarette count=6

Period 2 cigarette count=13

Period 1 incremental time value=0 hr 24 min

Period 2 incremental time value=1 hr 5 min

Graph 20 present the Day 3 values encountered by the example user. These values include:

Day 3 hold day goal (HDG)=17

Day 3 is reduction day, goal cigarettes per day (DG)=18. (Because DG>HDG)

Period 1 cigarette count=5

Period 2 cigarette count=13

Period 1 incremental time value=0 hr 30 min

Period 2 incremental time value=1 hr 5 min

Graph 21 present the Day 4, 5, 6, 7, 8, 9 values encountered by the example user. These values include:

Day 4, 5, 6, 7, 8, 9 hold day goal (HDG)=17

Day 4, 5, 6, 7, 8, 9 are hold days, goal cigarettes per day (DG)=17 (Because HDG=DG)

Period 1 cigarette count=5

Period 2 cigarette count=12

Period 1 incremental time value=0 hr 30 min

Period 2 incremental time value=1 hr 10 min

Graph 22 present the Day 10 values encountered by the example user. These values include:

Day 10 hold day goal (HDG)=15

Day 10 is a reduction day, goal cigarettes per day (DG)=16 (Because DG>HDG)

Period 1 cigarette count=5

Period 2 cigarette count=11

Period 1 incremental time value=0 hr 30 min

Period 2 incremental time value=1 hr 16 min

Graph 23 present the Day 11, 12, 13, 14, 15, 16 values encountered by the example user. These values include:

Day 11, 12, 13, 14, 15, 16 hold day goal (HDG)=15

Day 11, 12, 13, 14, 15, 16 are hold days, goal cigarettes per day (DG)=15 (Because DG=HDG)

Period 1 cigarette count=5

Period 2 cigarette count=10

Period 1 incremental time value=0 hr 30 min

Period 2 incremental time value=1 hr 24 min

Graph 24 present the Day 17 values encountered by the example user. These values include:

Day 17 hold day goal (HDG)=13

Day 17 is a reduction day, goal cigarettes per day (DG)=14 (Because DG>HDG)

Period 1 cigarette count=4

Period 2 cigarette count=10

Period 1 incremental time value=0 hr 40 min

Period 2 incremental time value=1 hr 24 min

Graph 25 present the Day 18, 19, 20, 21, 22, 23 values encountered by the example user. These values include:

Day 18, 19, 20, 21, 22, 23 hold day goal (HDG)=13

Day 18, 19, 20, 21, 22, 23 are hold days, goal cigarettes per day (DG)=13 (Because DG=HDG)

Period 1 cigarette count=4

Period 2 cigarette count=9

Period 1 incremental time value=0 hr 40 min

Period 2 incremental time value=1 hr 33 min

Graph 26 present the Day 24, 25, 26, 27, 28, 29 values encountered by the example user. These values include:

Day 24, 25, 26, 27, 28, 29 hold day goal (HDG)=12

Day 24, 25, 26, 27, 28, 29 are hold days, goal cigarettes per day (DG)=12 (Because DG=HDG)

Period 1 cigarette count=4

Period 2 cigarette count=8

Period 1 incremental time value=0 hr 40 min

Period 2 incremental time value=1 hr 45 min

Graph 27 present the Day 30, 31, 32, 33, 34, 35 values encountered by the example user. These values include:

Day 30, 31, 32, 33, 34, 35 hold day goal (HDG)=11

Day 30, 31, 32, 33, 34, 35 are hold days, goal cigarettes per day (DG)=11 (Because DG=HDG)

Period 1 cigarette count=3

Period 2 cigarette count=8

Period 1 incremental time value=1 hr 0 min

Period 2 incremental time value=1 hr 45 min

Graph 28 present the Day 36 and on values encountered by the example user. These values include:

Day 36 and on hold day goal (HDG)=10

Day 36 and on are hold days, goal cigarettes per day (DG)=10 (Because DG=HDG=GDG)

Period 1 cigarette count=3

Period 2 cigarette count=7

Period 1 incremental time value=1 hr 0 min

Period 2 incremental time value=2 hr 0 min

What is claimed is:

1. A period based time management smoking reduction method, to gradually reduce a user's smoking habit over time.

2. A period based time management smoking reduction method, to hold a user's smoking habit at a predetermined level.

3. A smoking reduction method as in claim 1 and 2, for determining time intervals between user smoking events.

4. A smoking reduction method as in claim 1 and 2, for scheduling time intervals between user smoking events.

5. A smoking reduction method as in claim 1 and 2, for determining smoking events at different interval rates of time, within a minimum of two distinct time periods.

6. A smoking reduction method as in claim 1 and 2, for scheduling smoking events at different interval rates of time, within a minimum of two distinct time periods.

7. A smoking reduction method as in claim 1 and 2, for scheduling smoking events, at different interval rates of time, within a multitude of additional time periods contained within the minimum two time periods.

8. A smoking reduction method as in claim 1 and 2, for determining intermediate reduction levels requiring hold days, with respect to the overall reduction schedule as a whole.

9. A smoking reduction method as in claim 1 and 2, for scheduling hold days at intermediate reduction levels, within the overall reduction schedule as a whole.

10. A smoking reduction method as in claim 1 and 2, that credits missed or skipped smoking opportunities, for consumption later within the daily reduction program as a whole.

11. An apparatus containing a period based, time interval smoking reduction method with means to affix to a user's wrist.

12. An apparatus as in claim 10, with means to provide visual display of the reduction method's scheduled time intervals between smoking events.

13. An apparatus as in claim 10, with means to provide visual display of the reduction method's daily and overall goals.

14. An apparatus as in claim 10, with means to provide visual display of a user's current status with respect to the reduction method's current goals.

15. An apparatus as in claim 10, with means to provide visual display of the current time period with respect to the reduction method's minimum two time periods.

16. An apparatus as in claim 10, with means for determining whether smoking events are occurring in the first minimum time period, or the second minimum time period.

17. An apparatus as in claim 10, with means to provide a visual display of the reduction method's starting cigarette count and goal cigarette count.

18. An apparatus as in claim 10, with means to provide visual display of whether the current day is a hold day or a reduction day, and with means to provide visual display of the reduction method's hold days within the overall reduction schedule as a whole.

19. An apparatus as in claim 10, with means for a user to enter and retrieve data related to the smoking reduction method and the users current status.

20. An apparatus as in claim 10, with means for a user to acknowledge the occurrence of a smoking event.
